(19) United States
(12) Patent Application Publication
(10) Pub. No.: US 2009/0132803 A1
(43) Pub. Date: May 21, 2009

(54) Secure Delivery System

(76) Inventors: Pete Leonard, Wheaton, IL (US); Abhay Pimprikar, Campbell, CA (US)

Correspondence Address: BANNER & WITCOFF, LTD., TEN SOUTH WACKER DRIVE, SUITE 3000, CHICAGO, IL, 60606, US

(21) Appl. No.: 11/943,273

(22) Filed: Nov. 20, 2007

(51) Int. Cl. H04L 9/00

(52) U.S. Cl. 713/150

(57) ABSTRACT

Aspects of the present invention provide systems and methods relating to storing and forwarding electronic files securely throughout the lifecycle of the file. One aspect of the invention relates to providing encrypted copies of electronic files that can only be unencrypted by the intended recipient.

### TECHNICAL FIELD

This invention relates to the secure, electronic delivery of files.

### BACKGROUND

As the Internet has increased in popularity, more and more information is being distributed electronically. As more information is distributed electronically, a need is growing for a method and system for delivering electronic files in a secure manner.

While some systems allow for secure connections between computers, there is a lack of security of files once transferred to another location. Essentially, the “pipe” between the source of a file and the destination of a file is secure but, once the file reaches its destination, anyone with access to that copy of the file can distribute it in an unsecured manner.

Thus, there is a need for systems and methods that provide security for electronic files both while the files are being transmitted and while the files are being stored. These and other advantages are successfully incorporated in embodiments of the present invention in a manner that can be incorporated in various environments.

### SUMMARY

Aspects of the invention relate to providing notice to a recipient of the availability of obtaining electronic files securely. Additional aspects of the invention allow for a recipient to choose when to securely download a copy of the electronic file. Aspects of the invention allow for version control of the electronic files, ensuring that the recipient obtains the most recent version of the electronic file from a repository when downloading the electronic file. Still other aspects of the invention allow for secure storage of the electronic file throughout its lifecycle on the recipient's machine.

One aspect of the invention relates to maintaining security of the electronic file so that it may only be accessed by intended recipients.

Of course, the systems of the above-referenced embodiments may also include other additional elements, steps, computer-executable instructions, or computer-readable data structures. Additional features and advantages of the invention will be apparent upon reviewing the following detailed description.

### BRIEF DESCRIPTION OF THE DRAWINGS

FIG. 1 illustrates an exemplary flowchart of a process of securely receiving and storing a copy of a file in accordance with an embodiment of the invention.

FIG. 2 illustrates an exemplary flowchart of a process of securely forwarding a file in accordance with an embodiment of the invention.

FIG. 3 illustrates a diagram depicting an exemplary embodiment of a user interface.

FIG. 4 illustrates one possible network configuration having a client/server network setup that may be used with select embodiments of the invention.

### DETAILED DESCRIPTION

Aspects of the invention relate to the secure transmittal, storage and forwarding of electronic files. In some embodiments of the invention, the system may be a private system, wherein a user may need to be invited to use the system and the user may need to obtain a digital certificate to access the electronic files.

The system may be used in combination with various other systems that may include the storage and delivery of electronic files. The following description includes references to using embodiments of the present invention with a system for managing healthcare records. These examples are merely intended to provide examples of how embodiments of the present invention may be integrated with other systems and are not meant to limit the embodiments to use with such systems.

The system may keep the file encrypted throughout the transfer and storage process. Some embodiments may encrypt the file during transfer by using https and, when the file arrives on a machine, the system may use a certificate to encrypt the file with a public key of the recipient so that the recipient may decrypt it with their private key. The encryption and decryption of the files may be transparent to users of the system—the users may not need to take any steps or actions to encrypt or decrypt other than simply using the system.

In certain embodiments of the invention, the system may be partially or wholly implemented with a computer-readable medium, for example, by storing computer-executable instructions or modules, or by utilizing computer-readable data structures.

Some aspects of the invention allow for an encrypted copy of a file to be sent to another computer and used by another user. In some embodiments, an initial e-mail may be sent to a potential recipient and the recipient may be provided with a link to download a digital certificate and software. In some embodiments, software may be installed on the recipient's computer. In such embodiments, an e-mail, which may include a link that launches software installed on the recipient's computer, may be sent to the intended recipient of the electronic file. An encrypted copy of the information may then be downloaded, so that the recipient may use copies of the identified information. The use of a file may be determined by the type of file that is being downloaded. For example, a document may be downloaded for viewing while and audio file may be downloaded for playing through an audio player. The encrypted copy of the information may only be decrypted for use with software provided in conjunction with the digital certificate provided by the system. Other than for use, the file may remain encrypted at all times, whether on the user's computer or in transit from one computer to another.

In one embodiment, the user may have an option to permanently decrypt a file that they have received through the system. For example, in an embodiment integrated with a healthcare record management system, a health care provider who receives a document through the system may want to load the document into their system. Loading a document that is encrypted may not be useful because only the user who was the intended recipient would be able to view the document if it were stored in an encrypted format. Therefore, the system may provide an option to decrypt the file and store an unencrypted file on the local machine. The user may then be able to store the file in some other database, presumably one that is secured through other means.

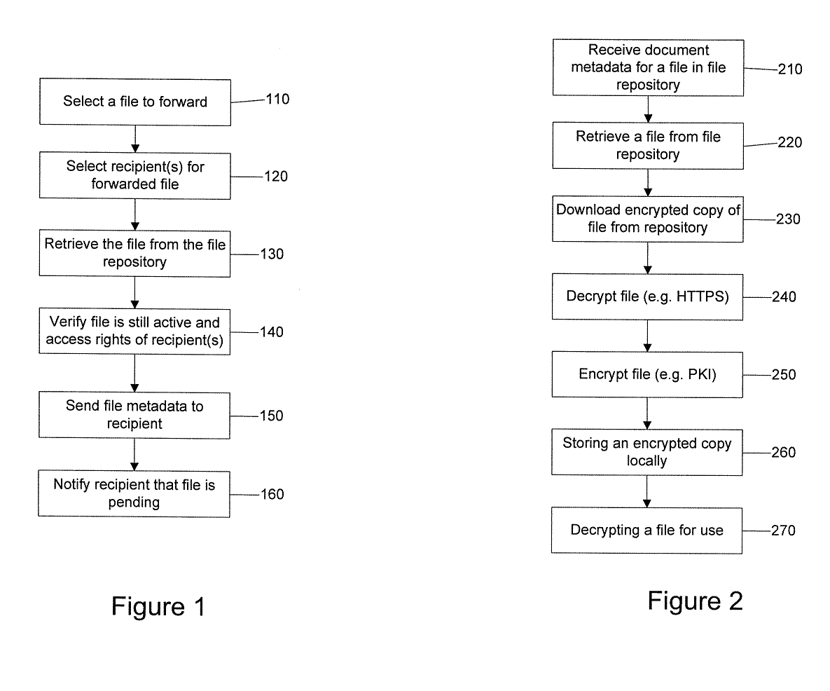

FIG. 1 provides an exemplary flowchart of the process of one aspect of the invention. In some embodiments of the invention, a user may select a file that the user would like to share with another user in step 110. After identifying the file to be sent, the user may select the other user(s) to whom the user will send the file in step 120. This may be done in many different ways. In one embodiment, when choosing to send a file in step 110, the user may be presented with a list of potential recipients. The potential recipients may be determined from a system that the embodiment of the invention is integrated with, from the users of the embodiment of the invention or from some other list of potential recipients accessible by the embodiment of the invention. For example, in embodiments that are integrated with a healthcare record management system, the list of users may come from the users that are authorized to access the healthcare record management system. In a healthcare record management system, it may make sense to limit the list of potential recipients to users that are in certain states or markets and the recipient list may therefore only include such users. Alternatively, another embodiment may only allow a user to select a recipient that the user has previously added to a recipient list. Some embodiments of the invention also may provide a search feature within the list of recipients to narrow the potential recipients by certain information, such as name, state, type of user, or other data stored for each user depending on the application.

Upon user selection of the file to be sent and the recipient(s), the system may then access the data repository where the file is stored in step 130. In certain embodiments the system may obtain just the information sufficient to access the file from the file repository while, in other embodiments, the system may obtain a copy of the file. In some embodiments, in step 140, the system may verify that the file is still active in the system and that the intended recipient(s) have proper access and authority to receive the file. In some embodiments of the invention, the system may then obtain the latest version of the file or information sufficient to access the latest version of the file from the file repository, send file metadata to the recipient(s) in step 150, and notify each of the intended recipients that a user has sent them the file in step 160.

FIG. 2 is an exemplary flowchart of an aspect of the invention. In one embodiment, the recipient may view file metadata for the file they have received through the system in their file “inbox” in step 210. The recipient's inbox may provide any combination of the information contained in the metadata; the metadata contains general information regarding the received file. For example, in an embodiment that is integrated with a healthcare record management system, the recipient may get information regarding the employer's name, the patient's name, and the type of document, such as a medical note, a billing invoice, or a work status report. In some embodiments, the only information that may be stored in a user's inbox is file metadata and all other identifying information may be accessed via a central server where the file information may reside. In some embodiments, the file metadata may include some combination of information regarding the file including, but not limited to, a file ID, a version ID, a patient ID, a patient name, a patient social security number, or a patient date of birth. In embodiments where the system merely accesses the file metadata, the recipient may not have to download the file at that time. The recipient may choose to download the file, delete the file from the recipient's inbox, or to take no current action on the file. In embodiments where the file metadata is sent to the recipient rather than the file, if the recipient chooses to download the file, the system may obtain a copy of the most recent version of the file from the file repository in step 220, encrypt the file and download the file to the recipient in step 230.

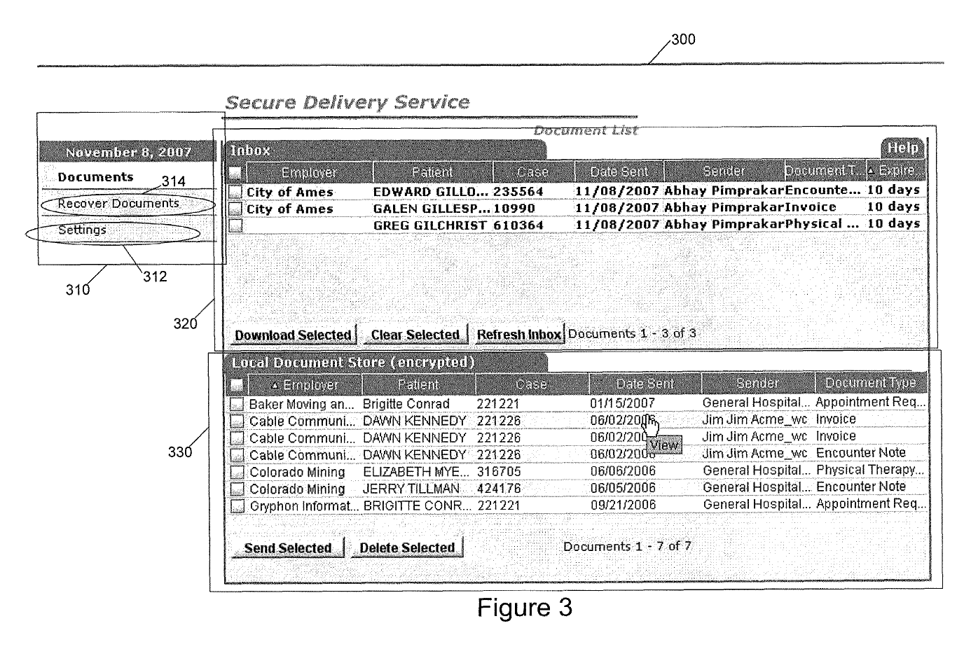

In one embodiment of the system, as depicted in FIG. 3, the user interface 300 may be divided into three panels—an upper panel 320, a lower panel 330 and a side panel 310. As can be seen from FIG. 3, side panel 310 may have a settings option 312 and a recover documents (or in an alternative embodiment, a recover file) option 314; upper panel 320 may be the “inbox”; and lower panel 330 may contain the files that the recipient has downloaded to the local file store (and not deleted).

Continuing with reference to FIG. 2, in some embodiments, clicking on the file in the inbox may automatically download the file in step 230, decrypt the file that was encrypted for transport in step 240, locally encrypt the file in step 250. In one embodiment, where the file may be transported via HTTPS (a secure socket layer over HTTP), the encryption using HTTPS would be decrypted in step 240 but the system may automatically encrypt the file locally in step 250 using another encryption method such as, for example, a public key infrastructure (“PKI”). Next, the system may store the encrypted file on a local file store in step 260 and temporarily decrypt the file for use in step 270. if the For example, if the file is a document, the file may be decrypted and automatically loaded into any appropriate application for viewing, such as a word processor, a browser, or other application for viewing documents in step 270.

Embodiments of the system provide an option to compare the recipient's local copy to the most recent version of the files in the repository or to allow a manual comparison to determine whether the local copy is the most recent version. In some embodiments, this comparison merely requires a comparison of the file metadata of the local copy to the file metadata of the copy in the file repository. Other settings and options available in some embodiments include setting how often the inbox checks for newly received files, deleting all downloaded files, checking for the latest version of the system, removing the system, or completely uninstalling the system, including deleting the downloaded certificate.

Other features available through the system in certain embodiments include using (such as, for example, viewing or playing), deleting, updating and forwarding any file that a recipient has received through the system. The forward process may be similar to the initial file selection and send process if integrated with another system. After selecting which file(s) to forward, the user may then select the new recipient(s) of the file. Once again, some embodiments may send the entire file(s), while other embodiments may just send the information necessary for accessing the file(s) from the file repository.

In some embodiments, the system may allow a user to delete files from the local file store. A user may elect to delete files if the local file store is too full or if there are so many files that it is too difficult to find specific files. A user may delete any file from the local file store. If the user then determines that they need a file that was deleted, the user may use the recovery feature available in some embodiments to recover previously received and deleted files. When selected, this feature may present the files that the user previously received and deleted and the user may choose one or more files to recover. Upon selecting the files, the system may obtain copies of the latest version of each of the recovered files and place them in the user's local file store. In addition to recovering previously downloaded and deleted files, the recovery feature may also be useful when a user experiences a hard drive crash, gets a new machine, or reinstalls their operating system. In these instances, a user may only need to select the recovery feature, select all files and every file previously downloaded by that user may be downloaded to the user's local file store. The recovery feature may be available in embodiments where a central server tracks the local file store lists.

In some embodiments of the invention, a user may be able to modify files in the system. In one aspect of the invention, if a user updates a document and attempts to upload the document, the system may determine whether to create a new file or a new version of a file. This determination may be made based on whether the author of the document is the same as the original author. The user may modify files using multiple editing tools based on the type of file the user is modifying. All of the files, irrespective of the format, may be stored in an encrypted form. When modifying the file, the system may choose the correct tool to edit the file based on the format of the file. The selection of an appropriate tool to edit the file may be transparent to the user.

Some embodiments of the invention may allow a user to encrypt an unencrypted file already existing on the user's machine. The user may then use the system to send the encrypted file to other users that can receive files encrypted by the system. Additionally, in embodiments of the system that are integrated with other systems, a user may send the encrypted file to the integrated system. For example, when embodiments of the present invention are used with a healthcare record management system, a user may transcribe notes in a word processing program, encrypt the notes through the system and send the encrypted notes to the integrated health record management system for storage and use by other users of that system.

As with other certificate-based systems, a user can be banned from using the system through revocation of their certificate. As previously explained, although a user need not take any action to encrypt or decrypt the files received, the system uses a certificate to decrypt the file for use by the user.

Files that are encrypted through embodiments of the present invention may be stored locally on a user's machine. Due to the method of encryption using public and private keys (such as PKI), as would be understood by one skilled in the art, if a user sends the locally stored, encrypted copy of the file to another person via some other means than the system, such as an email system, that person may not be able use the file. Even if the recipient is also a user of an embodiment of the present invention, only the intended recipient of the file who receives the file via the system may have the proper public and private keys to decrypt a file encrypted by embodiments of the present invention. Also as would be understood by one skilled in the art, the keys used for encryption may vary in length (e.g. 128-bit or 256-bit) based on the level of security desired.

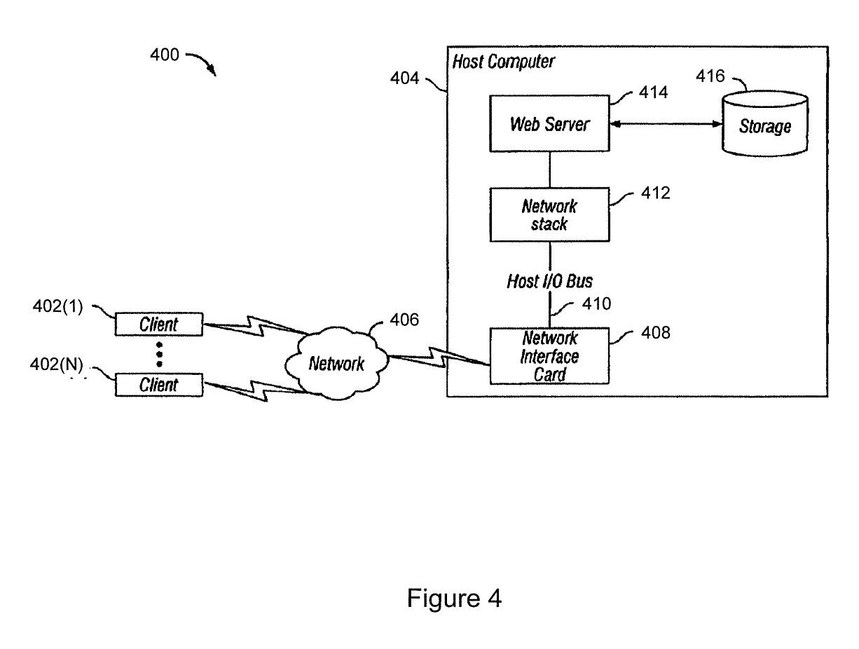

FIG. 4 illustrates an exemplary network configuration 400 in accordance with one embodiment of the invention. As shown in FIG. 4, an embodiment of the invention may allow various users to remotely access and monitor the information that is stored in the remote file repository through a network, such as the World Wide Web. FIG. 4 illustrates one possible network configuration (400) having a client/server network setup. In the network configuration 400, clients 402(1)-402(N) may each request information from a host computer 404 across a network 406. (N represents a whole number.) The client 402(1), for example, may send a request across the network 406 to access information related to a file. In one embodiment, the request may arrive at the host computer 406 at a network interface card (NIC) 408. From the NIC 408, the request may travel along an input/output (I/O) bus 410 and through a network stack 412 to web server 414 running web server software. The web server 414 may also comprise software to allow the system or be electronically connected to a computer-readable medium having the necessary software to allow access to the system.

The web server 414 may handle the request (including any necessary connection setup and information retrievals). The web server 414 may broker the secure connection between the client and the server. The web server 414 may then, if necessary, read information from a local storage mechanism 416 such as a buffer or a data cache. The web server 415 may then return any file or metadata requested by the client 402(1) to the client 402(1), with the content traveling through the network stack 412, the I/O bus 410, the NIC 408, and the network 406. Likewise, clients 402(1)-402(N) may each send and receive information through the network 406 to each other. The client/server configuration may allow users to access the system from anywhere in the world.

In some embodiments of the invention, the recipient of the electronic file(s) may pay for each file received. Payment may be determined in many ways depending on the application of the embodiment of the invention. Examples of how the recipient can be charged may include a per file, per byte, or per page basis. In these embodiments, the recipient might be charged as soon as the file enters the inbox or, in embodiments where the entire file is not downloaded until the recipient elects to download, the recipient might only be charged after electing to download the file. Alternatively, in some embodiments of the invention, the user who sends the file may be charged for the file instead of the recipient. In still other embodiments, such as where the embodiment is integrated with a healthcare record management system, the employer of the patient may pay for the files to be sent. In still other embodiments, there may be no charge for sending or receiving files.

In embodiments that require payment, the party responsible for payment may choose not to pay for certain types of files or for certain senders or recipients. In these embodiments, the system may still allow the files to be sent. However, when the recipient receives the file in their inbox, the recipient may be prevented from downloading the file. The system may present a message to the recipient indicating that the party responsible for payment has not allowed for the file to be downloaded. Additionally, in some embodiments, the system may notify the party responsible for payment and allow that party to elect to be charged. If the party elects to be charged, the recipient may then be able to download the file.

Whether or not the users are charged for sending or receiving files, some embodiments of the invention may track information regarding the sending and receiving of files. Various information may be tracked including what files were sent, who sent the files, to whom the files were sent, and whether and when each recipient looked at each file.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A method comprising:
downloading an encrypted file from a remote file repository;
automatically decrypting the encrypted file;
automatically locally encrypting the decrypted file;
automatically storing the locally encrypted file in a local file store; and
automatically temporarily decrypting the locally encrypted file for use,
wherein access to the file always includes decrypting the locally encrypted file.

2. The method of claim 1, further comprising:
temporarily storing the encrypted file in a secure online file store.

3. The method of claim 1, further comprising forwarding a copy of the file.

4. The method of claim 3, wherein forwarding a copy of the file comprises:
selecting the file to be forwarded;
selecting at least one recipient to forward the file to; and
sending file metadata to the recipient.

5. The method of claim 4, further comprising:
temporarily storing the file in a secure online file store prior to sending the file metadata to the recipient; and
notifying the recipient that the file is pending.

6. The method of claim 1, further comprising receiving file metadata of the file from the remote file repository prior to downloading the encrypted copy of the file.

7. The method of claim 1, further comprising:
selecting the file for editing; and
automatically selecting an editing tool for editing the selected file.

8. A computer-readable storage medium comprising computer-executable instructions that, when executed:
retrieve a file from a remote file repository;
download an encrypted copy of the file from the remote file repository;
automatically decrypt the encrypted copy of the file;
automatically locally encrypt the decrypted copy of the file;
automatically store the encrypted copy of the file in a local file store;
automatically temporarily decrypt a copy of the encrypted file for use; and
automatically remove the decrypted copy of the encrypted file after use.

9. The computer-readable storage medium of claim 8, wherein the computer-executable instructions, when executed, temporarily store the encrypted copy of the file in a secure online file store.

10. The computer-readable storage medium of claim 8, wherein the computer-executable instructions, when executed, forward a second copy of the file.

11. The computer-readable storage medium of claim 10, wherein the computer-executable instructions, when executed to forward a second copy of the information:
select a file to be forwarded;
select at least one recipient to forward the file to;
securely retrieve the file from the remote file repository; and
send file metadata to the recipient.

12. The computer-readable storage medium of claim 11, wherein the computer-executable instructions, when executed:
temporarily store the file in a secure online file store prior to sending the file metadata to the recipient; and
notify the recipient that the file is pending.

13. The computer-readable storage medium of claim 8, wherein the computer-executable instructions, when executed, receive file metadata of a file on the remote file repository prior to downloading the encrypted copy of the file.

14. The computer-readable storage medium of claim 8, wherein the computer-executable instructions, when executed:
select a file for editing; and
automatically select an editing tool for editing the selected file.

15. An apparatus comprising:
a storage medium; and
a processor, the processor operatively coupled to the storage medium, the processor configured to:
retrieve a file from a remote file repository;
download an encrypted copy of a file from the remote file repository;
automatically decrypt the encrypted copy of the file;
automatically locally encrypt the decrypted copy of the file;
automatically store the encrypted copy of the file in a local file store;
automatically temporarily decrypt a copy of the encrypted file for use; and
automatically remove the decrypted copy of the encrypted file after use.

16. The apparatus of claim 15, wherein the processor is further configured to temporarily store the encrypted copy of the file in a secure online file store.

17. The apparatus of claim 15, wherein the processor is further configured to forward a second copy of the file.

18. The apparatus of claim 17, wherein the processor is further configured to:
select the file to be forwarded;
select at least one recipient to forward the second copy of the file to;
securely retrieve the file from the remote file repository; and
send file metadata to the recipient.

19. The apparatus of claim 18, wherein the processor is further configured to:
temporarily store the file in a secure online file store prior to sending the file metadata to the recipient; and
notify the recipient that the file is pending.

20. The apparatus of claim 15, wherein the processor is further configured to receive file metadata of the file on the remote file repository prior to downloading the encrypted copy of the file.

21. The apparatus of claim 15, wherein the processor is further configured to:
select the file for editing; and
automatically select an editing tool for editing the selected file.
